(19) United States
(12) Patent Application Publication
(10) Pub. No.: US 2014/0263919 A1
(43) Pub. Date: Sep. 18, 2014

(54) MULTI-FUNCTIONAL SLATS FOR USE IN VARIOUS SUPPORT STRUCTURES

(71) Applicant: Tripar Intemational Inc., (US)

(72) Inventors: Marta Duffy, Elgin, IL (US); Gretchen Kroll, Medina, MN (US)

(73) Assignee: Tripar Intemational Inc., Roselle, IL (US)

(21) Appl. No.: 13/798,749

(22) Filed: Mar. 13, 2013

(51) Int. Cl. F16M 13/02; A47B 7/00; A47F 5/00

(52) U.S. Cl. CPC F16M 13/02; A47F 5/00; A47B 7/00
USPC 248/415; 211/134; 248/158; 248/205.1; 211/87.01; 108/161

(57) ABSTRACT

An improved slat is disclosed with enhanced functionality and versatility. In accordance with one aspect of the invention, each slat provides multiple vertical positions for receiving brackets. In addition, such slats may include an optional decorative characteristic that can be incorporated into other display devices, such as tables and shelves to increase the functionality and versatility of those devices while providing a decorative flair. The slats in accordance with the present invention can be incorporated into non-linear display devices, for example, cylindrical display devices that can be used for displaying various items, such as earring cards, headbands and other items. Heretofore, such slats have only been used in linear applications. Such slats can also be used in freestanding displays both floor displays and counter-top displays which provide multiple sided functionality. Accordingly, the slats in accordance with the present invention provide enhanced functionality and versatility relative to known slats.

### BACKGROUND OF THE INVENTION

1. Field of the Invention

The present invention relates to slats for displaying merchandise by way of brackets and more particularly slats adapted to be carried by different support structures in which the slats can be either linear or non-linear and each slat provides multiple vertical bracket locations.

2. Description of the Prior Art

Various types of displays are used for displaying various types of articles. Such displays are used in retail stores. Display tables and racks are used in retail stores to display various items including clothing items. Many clothing items are displayed on clothing racks and tables. In order to draw attention to various clothing items, certain clothing items are displayed on life size mannequins. The mannequins are normally located in proximity to the clothing rack or table where the particular clothing items, jewelry, and other items are available.

In order to optimize the display space in a retail store, the store walls are known to be used to display items. One known method of displaying items on a wall of a retail store is by way of slat walls and complementary brackets. Examples of slat walls are disclosed in US Patent Application Publication Nos. 2012/0247044; 2011/0303798; 2011/0185667; 2010/0132268; 2010/0028592; 2009/0200253; 2005/006539; and 2001/0047971. Examples of slat walls are also disclosed in U.S. Pat. Nos. 6,491,172; 6,6349,507 and 5,121,578, all of the above hereby incorporated by reference. Examples of brackets for slat walls are disclosed in US patent application publication nos.: 2010/0288891 and 2004/0118985, also incorporated by reference.

Slat walls are formed by a number of parallel rails or slats evenly spaced apart supported by a wall. The slats are secured to a wall horizontally and allow brackets to be located in virtually any position along the length of the slat at the same vertical height from the floor. The vertical height of a bracket is varied by moving the bracket to a higher or lower slat on the wall. As such, the slat walls provide virtually unlimited possibilities for displaying merchandise along a wall.

Such slat walls form a support interface for receiving brackets that are configured to be removably carried by the slats. The brackets used with such slat walls are known to be available in various configurations. For example, slat wall brackets with hooks, straight arms and so-called waterfall configurations are known to be used to display clothing items on clothes hangers. Accessory items are known to be displayed on waterfall arms with hooks. Shelf brackets and shelves are also known for use with slat walls which allow various configurations of shelves for displaying various items. An example of a shelf for use with a slat wall is disclosed in U.S. Pat. No. 5,941,026.

Slat walls have also been developed as free standing devices. In such devices, the slat wall is formed with a number of horizontal parallel and spaced apart slats mounted to a rigid substrate forming a slat wall. The slat wall is mounted to a base to enable the slat wall to be free standing. An example of a free standing slat wall is described in U.S. Pat. No. 6,164,467.

Although slats, as described above, provide an easy and convenient way of means to display various retail items. There has been little or no effort to improve on the basic concept of providing a plurality of spaced apart rails.

### SUMMARY OF THE INVENTION

Briefly, the present invention relates to various improvements in slats for improving the functionality and versatility of such slats while at the same time optionally integrating the functionality with decorative characteristic. In accordance with one aspect of the invention, each slat provides multiple vertical positions for receiving brackets. In addition, such slats may include an optional decorative characteristic that can be incorporated into other display devices, such as tables and shelves to increase the functionality and versatility of those devices while providing a decorative flair. The slats in accordance with the present invention can be incorporated into non-linear display devices, for example, cylindrical display devices that can be used for displaying various items, such as earring cards, headbands and other items. Heretofore, such slats have only been used in linear applications. Such slats can also be used in freestanding displays both floor displays and counter-top displays which provide multiple sided functionality. Accordingly, the slats in accordance with the present invention provide enhanced functionality and versatility relative to known slats.

### DESCRIPTION OF THE DRAWING

These and other advantages of the present invention will be readily understood with reference to the following specification and attached drawing wherein:

FIG. 1 is an isometric view of a single slat in accordance with the present invention, shown supported between two spaced apart vertical posts and further shown carrying three exemplary brackets at three different vertical positions.

FIG. 2 is a front elevational view of an assembly of multiple carried by a frame that can be attached to a wall or used to form a free standing floor display, as illustrated in FIG. 4, or a counter top display, as illustrated in FIG. 5.

FIG. 3 is a partial isometric view of a slat attached to a vertical support by way of an adjustment bracket that can be used to attach the slat to a vertical support and allow the height of the slat to be easily and conveniently adjusted.

FIG. 4 is an isometric view of a freestanding floor display incorporating the slats in accordance with the present invention.

FIG. 5 is an isometric view of a freestanding counter top display incorporating the slats in accordance with the present invention.

FIG. 6 is an isometric view illustrating slats in accordance with the present invention incorporated into a table.

FIG. 7a is an isometric view illustrating slats in accordance with the present invention incorporated into a shelf.

FIG. 7b is a front elevational view of the shelf illustrated in FIG. 7a.

FIG. 7c is a side elevational view of the shelf illustrated in FIG. 7a.

FIG. 8 is a freestanding counter top display formed with multiple tiers of slats integrated into a cylindrical structure.

FIG. 9 is a freestanding counter top display with a single slat formed in a cylindrical shape supported by a vertical rod and a base.

FIG. 10 is a freestanding counter top display incorporating multiple tiers of slats integrated into a cylindrical structure that includes tabs for displaying cards, such as earring cards.

FIG. 11 is a freestanding counter top display incorporating multiple tiers of slats incorporated into a cylindrical display used for displaying headbands and earrings.

FIG. 12 is a freestanding counter top display, which includes a single slat formed in a circular configuration supported by a vertical rod and base.

FIG. 13 is a freestanding floor display configured as a hat stand illustrating a number of slats in accordance with the present invention formed in a circular configuration connected to a vertical rod by way of support arms in which the rod is supported by a base forming a tree.

FIG. 14 is an isometric view of an exemplary bracket for use with the slat in accordance with the present invention.

FIG. 15 is an isometric view of an alternate embodiment of the bracket illustrated in FIG. 14.

FIG. 16 is an isometric view of a bracket for use in accordance with the present invention that incorporates a slat in a circular configuration formed on one end.

FIG. 17 is an isometric view of an earring card that can be displayed in the slats in accordance with the present invention or on the display illustrated in FIG. 18.

FIG. 18 is a partial isometric view of the earring card, illustrated in FIG. 17, displayed on a slat in accordance with the present invention.

FIG. 19a is front isometric view of shelf configured to attach to a slat in accordance with the present invention.

FIG. 19b is rear isometric view of shelf configured to attach to a slat in accordance with the present invention

### DETAILED DESCRIPTION

The present invention relates to various improvements in slats for improving the functionality and versatility of such slats while at the same time optionally integrating the functionality with a decorative characteristic. In accordance with one aspect of the invention, each slat provides multiple vertical positions per horizontal location for receiving brackets. In addition, such slats may have an optional decorative characteristic that can be incorporated into other display devices, such as tables and shelves to increase the functionality and versatility of those devices while providing a decorative flair. The slats in accordance with the present invention can be incorporated into non-linear display devices, for example, cylindrical display devices that can be used for displaying various items, such as cards, headbands, tools and other items. Heretofore, such slats have only been used in linear applications. Such slats can also be used in freestanding displays both floor displays and counter-top displays which provide multiple sided functionality. Accordingly, the slats in accordance with the present invention provide enhanced functionality and versatility relative to known slats.

The slats in accordance with the present invention fall into various categories, which provide enhanced functionality and versatility. The slats may be formed in various configurations, such as linear and cylindrical configurations. In addition, the slats may be wall mounted, freestanding floor mounted or counter top mounted and may be incorporated with other merchandising display items.

FIGS. 1-5 illustrate various applications of the slats in a linear configuration. FIGS. 6-7c, 10 and 11 illustrate applications of the slats incorporated into other display devices. FIGS. 8-13 illustrate applications of the slats in a non-linear configuration, such as a circular configuration and a cylindrical configuration. FIGS. 14 and 15 illustrate exemplary brackets in accordance with the present invention while FIG. 16 illustrates a bracket with a slat in a circular configuration on one end. FIG. 17 illustrates a card for carrying small items, such as earrings, defining slim carded items, that can be displayed in the slats in accordance with the present invention, for example, as illustrated in FIG. 18. FIG. 19a illustrates a shelf configured to attach to a slat in accordance with the present invention, as illustrated, for example, in FIG. 19b.

Referring first to FIG. 1, an exemplary slat in accordance with the present invention is illustrated and generally identified with the reference numeral 50. The slat can be scaled to be used in various applications, such as a wall mounted application, mounted by way of conventional means, as illustrated in FIG. 2, a freestanding floor display, as illustrated in FIG. 4, as well as a freestanding counter top display, as illustrated in FIG. 5, and other configurations. The slat 50 is merely exemplary and includes multiple vertical locations per horizontal location for attaching complementary brackets. As shown, the slat 50 is shown with three (3) brackets 52, 54 and 56 all shown at different vertical locations. Although not shown, a fourth bracket can be attached to a top rail 58 of the slat 50. Although slats configured to accept brackets in three (3) vertical locations are described and illustrated, other slats configured to receive brackets in multiple vertical positions, for example, 2 vertical positions and >3 vertical positions are contemplated to be within the broad scope of the invention.

In one embodiment, the slat 50 is formed as an elongated linear device with a horizontal top rail 58 and a horizontal bottom rail 60. A horizontal center band, generally identified with the reference numeral 62 may be juxtaposed between the upper rail 58 and the lower rail 60 and attached to the upper and lower rails 58 and 60 by way of a plurality of spaced apart spokes, generally identified with the reference numeral 64. Upper and lower slots 66 and 68 respectively, are formed adjacent the upper rail 58 and the lower rail 60. These slots 66 and 68 are configured to receive multiple brackets 52 and 56 at different vertical heights at each horizontal location. The center band 62 may be formed with or without a center slot, depending on the decorative design characteristic. The upper and lower slots 66 and 68 as well as the center slot can be located so that two or more of the slots are at least partially aligned or alternatively such that none of the slots are aligned. The horizontal center band 62 and the horizontal top and bottom rails 58 and 60, respectively, are connected on each end to vertical interconnection members 70 and 72.

In accordance with one aspect of the present invention may optionally be formed with a center band 62 with a decorative characteristic. As shown, the decorative characteristic includes a repeating design of elongated oval 74 and diamond shapes 76 connected to an upper band rail and a lower band rail, 78 and 80, respectively, forming irregular shaped cutouts, generally identified with the reference numerals 82 and 84. The elongated oval shapes 74 are formed as cutouts, which provide a support surface for a bracket, as shown, at a different vertical height than the upper and lower slots 66 and 68, respectively.

As mentioned above, the center band 62 may be formed without decorative characteristic and may simply include a solid band (not shown) with repeating slots configured to receive a bracket, such as the bracket 54 at a height different than the heights of the brackets 52 and 56. The center band 62 can optionally be formed as a solid band (not shown) with no slots or with different decorative designs than shown in FIG. 1. All such configurations are considered to be within the broad scope of the invention.

The slats 50 may be made from iron sheet metal, for example, 1.5 mm thick. A die in the shape of the pattern is used to stamp and cutout the pattern, or the pattern may be laser cut, for example, the pattern illustrated in FIG. 1. The linear patterns are welded to a frame and are optionally powder coated with various finishes.

FIG. 2 illustrates a merchandising display configured as a rectangular rack 86 that may be used as a wall panel in which the patterns, generally identified with the reference numeral 88, are stamped or laser cut from a common substrate, for example, a rectangular sheet of iron sheet metal 90, for example a sheet 33″ wide×58.2″ high. The sheet 90 with the patterns 88 are welded to horizontal frame members 92 and 94 and vertical frame members 96 and 98 to form a wall panel which can be secured to a wall with conventional brackets and fasteners. The thickness of the frame members 92, 94, 96 and 98 is selected to sufficiently space the rack from the wall to enable brackets to attached to the slats 88, as shown in FIG. 1. The entire rack 86 may be powder coated as discussed above.

FIG. 4 illustrates an embodiment in which a number of slats 50 are supported by a freestanding frame, generally identified with the reference numeral 100. In this embodiment, the free standing frame includes spaced apart vertical support members 102 and 104, for example formed from 25 mm×25 mm tubes, 71.75″ in length. The vertical support members 102 and 104 are connected together by two or more fixed horizontal support members 106 and 108, for example 25 mm round tubes, 28 inches in length. One end of each of the vertical support members 102 and 104 is connected to a floor stand 110 and 112, respectively defining a freestanding floor frame.

As best shown in FIG. 3, an adjustable bracket assembly 116 may be rigidly connected to each end of a slat 50. As shown the bracket assembly 116 may include a track 114 for rigidly connecting to one end of a slat 50. The track 114 may be rigidly connected to an “C” shaped bracket 118. The “C” shaped bracket is sized to receive a vertical support member 102 or 104. The brackets 118 include threaded apertures (not shown) for receiving a threaded fastener 120, illustrated in FIG. 3 as a hook. The fastener 120 allows the compression force between the bracket 118 and the vertical supports to be varied to allow height of the slats 50 to be easily adjusted up and down and also allow slats to added and removed. FIG. 3 illustrates an exemplary bracket 116 for use with the freestanding floor display illustrated in FIG. 4.

FIG. 5 illustrates a merchandising display configured as a freestanding counter top display, generally identified with the reference numeral 126. The display 126 includes a number of vertically spaced slats 50 die-cut from a sheet 128 of rectangular sheet metal, for example 1.5 mm thick. In the exemplary design illustrated in FIG. 5, the slats 50 are spaced apart by vertical members 127, shaped, for example, as diamonds. The sheet 128 is welded to a frame, generally identified with the reference numeral 130.

In this application, except for the top slat 50, slots 131 and 133 are formed above each slat. These slots 131 and 133 allow brackets, like the bracket 52 (FIG. 1) to be hung on a top edge 135 of each slat 50. Similarly brackets can be hung in the elongated oval shaped cutouts 137 allowing each slat 50 to carry brackets 52 at different heights. In the embodiment shown, the top slat 50 is up against a top portion of the frame. Thus, brackets 52 (FIG. 1) can only be hung in the elongated oval shaped cutouts. Alternatively, the free standing counter top display 126 can be configured so that the top slat 50 is spaced away from the top member of the frame 130 so as to form a slot between the slat 50 and the top frame member.

A bottom end of the frame 130 is connected to a base 132 by way of a vertical rod 134. The rod 134 may be rotatably connected to the base 132 forming a counter top base assembly. A ball 139 or optional decorative element may be connected to a top end of the frame 130 by various methods including the irregular shaped members 138 and 140 shown to enable users to rotate the display by grasping the ball or decorative element. The base 132 may include a partial slat 136, which does not include the slots 66 and 68 (FIG. 1) as discussed above.

FIGS. 6 and 7 illustrate embodiments of merchandising displays in which the slats in accordance with the present invention are incorporated into other display items, thereby providing enhanced functionality and versatility. The slats in accordance with the present invention can be incorporated in a number of display devices. For example, FIG. 6 illustrates an embodiment in which slats, generally identified with the reference numeral 140 are incorporated into a multi-functional merchandising table, generally identified with the reference numeral 142. FIGS. 7a-7c illustrate an embodiment in which slats 143 are incorporated into a shelf, generally identified with the reference numeral 144. The slats 140 can also be incorporated into other display items. As such, the slats 140 in accordance with the present invention provide enhanced versatility to various display items.

Referring first to FIG. 6, the multi-functional merchandising table 142 includes a tabletop 146 and at least one leg and may include a plurality of table legs 148, 150, 152 and 154. In the exemplary configuration illustrated in FIG. 6, multiple slats 140 can be juxtaposed just beneath the tabletop 146. Each slat 140 may be disposed between a pair of table legs. For example, one slat may be disposed between the table legs 148 and 152. A second slat may be disposed between the table legs 152 and 154. A third slat may be disposed between the table legs 148 and 150 while a fourth slat may be disposed between the table legs 150 and 154. The table 142 thus allows merchandise to be displayed on the tabletop 146 as well as hung from the sides by way of one or more brackets, such as the brackets 52, 54 and 56 (FIG. 1). Clothes or merchandise hangers (not shown) can be hung through a bottom slot of the slat 140.

Various configurations of the table are contemplated. For example, various heights of the table 142 are contemplated. For example, the table may be made with a height of 722 mm or 878 mm or other heights. Various configurations of the tabletop 146 are also contemplated. For example, the tabletop 146 may be square, for example 560 mm×560 mm or 805 mm×805 mm or other dimensions. The tabletop 146 may have other configurations as well. For example, the table top 146 may be formed with a square or rectangular shape, as shown in FIG. 6, or other shapes, such as circular, oval, triangular or polygonal shapes or other shapes.

FIGS. 7a-7c illustrate multi-functional merchandising display shelf 144 that may also incorporate slats 143 in accordance with the present invention. FIG. 7a illustrates an isometric view of a single tier shelf 144 that incorporates the slats 143 in accordance with the present invention. FIG. 7b illustrates a front elevational view, while FIG. 7c illustrates a side elevational view of the shelf illustrated in FIG. 7a. The shelf includes a mantle 156. In this exemplary embodiment, the shelf 144 is configured as a wall shelf with the slats 143 disposed beneath the mantle 156 on three sides 158, 160 and a third side (not shown). In an alternate embodiment, the slats 143 can be disposed beneath the mantle on all four sides forming a freestanding shelf which can be placed on a table or counter.

Various size shelves 144 are contemplated. For example, the shelf 144 may include a mantle 156 that is formed in the shape of a rectangle, for example 32×10 inches. A front slat may be formed to be 29 inches in length allowing for 1½-inch overhang of the mantel 156 on each end. The slats 142 used, as end panels may be 6 inches long allowing for a 4-inch overhang of the mantel 156 in front. Other dimensions are also suitable.

Multiple tiers of shelves 144 with different lengths. Such shelves may be used in wall configurations, for example, in which the shelves 144 are mounted on a wall with one above the other. In such a configuration, the shelves may be mounted to the length of the shelves increases as the height of the shelves from the floor decreases. Other configurations are also contemplated.

FIG. 8 illustrates a freestanding merchandising display configured as a counter top jewelry display, generally identified with the reference numeral 162. The jewelry display includes an upright portion 164 and a base 166. The upright portion 164 may be rotatably attached to the base 166 by conventional methods or alternatively rigidly attached to the base 166. In embodiments in which the upright portion 164 is rotatably attached to the base 166, a knob 168 may be rigidly attached adjacent the top of the upright potion 164 which facilitates rotation of the upright portion without interfering with merchandise (not shown) being carried by the display 162.

The upright portion 164 is illustrated with an exemplary cylindrical structure with a circular cross-section. Embodiments in which the slats are formed in a circular configuration, for example, as shown in FIGS. 8-13, may be initially formed from a flat blank that has been stamped or laser cut with the desired slat pattern forming flat slat stock. The flat slat stock may then be hand formed to exact circular diameters using a mandrel, for example, to ensure consistent size. The free ends of the flat slat stock may then be attached together, for example, by conventional welding or other techniques, to form a circular slat configuration, for example, as illustrated in FIGS. 8-13.

Other configurations, such as or other non-linear configurations, are contemplated within the broad scope of the invention. For example, the upright portion 164 may be formed with a square, triangular or polygonal cross section. In these embodiments, appropriate fixtures are used to bend the flat slat stock into the appropriate shape. The free ends of the flat slat stock are then attached together as discussed above.

The base 166 is shown with a circular cross-section. Other configurations of the base 166 are contemplated. For example, the base 166 may be formed with a square, triangular or polygonal cross section.

The upright portion 164 is shown with an exemplary five (5) bands of slat portions 172, 174, 176, 178 and 180, integrated into the upright portion 164. More or fewer bands of slat portions 172, 174, 176, 178 and 180 may be incorporated into the upright portion 164. As shown, the bands of slat portions 172, 174, 176, 178 and 180 are spaced apart from each other. As mentioned above, each band 172, 174, 176, 178 and 180 provides three vertical locations for receiving brackets for carrying merchandise, which provides increased versatility and functionality.

In an exemplary embodiment shown, the upright portion may be formed to be 610 mm in height and have a diameter of 140 mm. The base is shown with a circular cross section, for example 240 mm in diameter and 19 mm in height. Each band 172, 174, 176, 178 and 180 may be formed with a 50 mm width and spaced 50 mm apart.

FIG. 9 illustrates a freestanding merchandising display configured as a single hat stand display, generally identified by the reference numeral 182. The hat stand display includes a cup portion 184 for carrying a hat, a base 186 and a vertical support 188. The vertical support 188 rigidly attaches the cup portion 184 to the base 186.

The cup portion 184 may be open top, as shown, but may include a floor portion 190 or a plurality of spokes (not shown) for connection of the cup portion 184 to the vertical support 188. The optional floor portion 190 or spokes may be formed in a circular configuration from the same material as the cup portion 184 and the base 186. The floor portion 190 or spokes are secured to the vertical support by various conventional methods, such as welding.

Alternatively, the floor portion 190 can be eliminated. In this embodiment, the upper end of the vertical support 188 can be secured to the inside perimeter of the cup portion 184. In this embodiment, the size of the base portion 186 may be increased relative to the embodiment that includes a floor portion in order to compensate for the change of the center of gravity of the hat stand 182.

The cup portion 184 in FIGS. 9 and 13 may be formed from relatively thinner iron sheet metal than the slats used in other displays. For example, the cup portion 184 may be formed from 0.6 mm thick iron sheet metal whereas the slats used in other displays may be formed from 1.5 mm iron sheet metal. The circular configuration of the cup portion 184 may be formed, as discussed above.

Various dimensions for the single hat stand 182 are contemplated. For example, the hat stand 182 may be formed to be 14 inches high. The cup portion 184 may be formed from a slat that is 3 inches high and formed with a diameter of 4 inches. The vertical support 188 may be a rod, for example, 7 mm in diameter. The vertical support 188 may be secured to the base by various conventional methods. The base 186 may be formed in various shapes, for example, the base 186 may be formed as an oval, for example, 95 mm×135 mm.

FIG. 10 illustrates a freestanding merchandising display configured as an earring card display 192. The earring card display is configured as a cylindrical structure, for example 14 inches high and 5¼ inches in diameter. The cylindrical structure includes circular slats 194 and 196 adjacent the top and the bottom, respectively, of the cylindrical structure and a center portion 198. The center portion 198 of the cylindrical structure is used for carrying earring cards, photos, and other various slim-carded items that consist of a generally flat substrate and are not formed with a hook on one end, as shown in FIG. 17. The center portion 198 includes a plurality of radially outwardly facing tabs, generally identified with the reference numeral 200. Each tab 200 is configured to carry an earring card. The slats 194 and 196 allow coordinating jewelry and various items to be displayed by way of one or more brackets. 52, 54 and 56 (FIG. 1).

The earring card display 192 may be formed from a flat sheet of iron sheet metal. The iron sheet metal is stamped or laser cut with the slats 194 and 196 and the tabs 200, forming a flat slat stock. The flat slat stock may be hand formed around a mandrel forming the cylindrical structure so that the tabs 200 extend outwardly. The free ends of the flat slat stock are attached together, as discussed above to form the earring card display 192.

FIG. 11 illustrates a merchandising display configured as a headband display 202. The headband display 202 is formed as a cylindrical structure and includes at least one slat and may include upper and lower slats 204 and 206 and a center portion 207. The headband display is similar to the earring card display 192 with the only difference being the center portion 206. In the case of the headband display 202, a plurality of holes is provided for carrying pierced earrings. The holes may be provided in a pattern, as illustrated in FIG. 11 or virtually any pattern or no pattern at all can be used.

The headband display may be formed to be 14 inches high and 4¾ inches in diameter. Headbands may be displayed along with coordinating jewelry from one or more brackets 52, 54 and 56 (FIG. 1) carried by the slats 204 and 206. In addition, the holes illustrated in FIG. 11 may be used to carry pierced earrings (not shown). In particular the earring post (not shown) may be inserted into one of the holes 208 in the perforated pattern and secured from the inside of the headband display by its corresponding retainer (not shown). This piece can also be wall mounted to hang vertically

FIG. 12 illustrates a merchandising display configured as a purse stand display 210. The purse stand includes a cylindrical portion a slat portion 212, a vertical support 214 and a base 216. The purse stand may be formed to be 36 inches high with the slat portion 212 formed to be 3 inches in height and 24 inches in diameter. The vertical support 214 may be formed as a rod 19 mm in diameter. The base 216 may be formed to be 13½ in diameter and have a thickness of 40 mm.

The slat portion 212 is formed with a plurality of axially directed posts, generally identified with the reference numeral 218 from a top rail 222 of the slat portion 212. The posts 218 may be formed with a ball portion 220 on an extending end. The slat portion 212 is formed from a flat sheet of iron sheet metal. The iron sheet metal is stamped or laser cut to form the slats along with the posts 218 and optional balls 220, to form a flat slat stock. The flat slat stock may be hand formed around a mandrel forming the cylindrical structure, as shown. The free ends of the flat slat stock are attached together, as discussed above, to form a circular slat, as shown.

One or more spokes, generally identified with the reference numeral 224 are connected to a bottom rail 226 of the circular slat to create a connection point for connecting one end of the vertical support 214 to the circular slat portion, by conventional methods. The other end of the vertical support 214 is rigidly attached to the base 216 by conventional methods.

The purse stand display 210 is convenient for displaying purses with straps (not shown). The purse straps are looped over vertically oriented posts 220, disposed along an upper edge of said cylindrical portion, thereby allowing the purses to hang freely. The slat portion 212 allows other items, such as jewelry, scarves, or tools to be displayed with the purses by way of one or more brackets 52, 54 and 56 (FIG. 1), thus providing a single display with increased versatility.

FIG. 13 illustrates a merchandising display configured as a freestanding hat tree display 228. The hat tree display 228 includes a number of cup portions, generally identified with the reference numeral 230. The cup portions 230 may be formed virtually the same as the cup portions 184 illustrated in FIG. 9. The hat tree display 228 also includes a vertical support 232 that may be sized so that the hat tree display 228 can be floor standing or counter top standing. One end of the vertical support 232 is connected to a base 234 by conventional methods. The other end is free. Each of the cup portions 230 is attached to the vertical support 232 by way of an “L” shaped bracket, generally identified with the reference numeral 236.

As shown, multiple tiers of cup portions 230 are attached to the vertical support 232. The number of tiers is dependent in part on whether the tree display 228 is floor standing or standing. For an exemplary floor standing model, the vertical support 232 may be 67 inches long and 22 mm in diameter. The first tier of cup portions 238 may be 18 inches from the floor. Each tier of cup portions may be spaced 13 inches apart. The cup portions 230 may be 4 inches in diameter and 3 inches high. The “L” shaped brackets 236 may be 6 mm in diameter and may consist of two legs, generally identified with the reference numerals 240 and 242, sized to be 3 inches and 10 inches, respectively. The base 234 may be 13½ inches in diameter and 40 mm thick. Other dimensions are also suitable. Brackets, such as the bracket 244, illustrated in FIG. 14, can be attached to cup portions 230 for increased versatility.

As mentioned above, the hat tree display 228 can be scaled down and formed as a counter top display. Each tier of cup portions 230 may be formed with a plurality of cup portions at the same height. Four cup portions 230 are shown per tier. More or fewer cup portions per tier are also contemplated. Moreover, embodiments are contemplated in which the cup portions are not at the same height. All such embodiments are considered to be within the broad scope of the invention.

FIGS. 14 and 15 illustrate exemplary brackets 244 and 246, respectively, for use with the slats in accordance with the present invention. Referring first to FIG. 14, the bracket 244 includes a connecting portion 248 and a cantilevered hook portion 250. The connecting portion may be formed as an inverted “J”, as shown having a bight portion 252 sized to receive a slat rail, such as a slat 78 (FIG. 1) or an upper or lower band rail 58, 60. For example, for slats made from 1.5 mm iron sheet metal, the bight portion 252 is sized to be slightly larger than 1.5 mm. Other dimensions are also suitable. The length of the hook portion 250 may be 3 or 5 inches. The hook portion 250 may be formed from a 6 mm diameter rod in various configurations. For example, the hook portion 250 may be attached to the connecting portion 248 in a generally perpendicular relationship with a hook 253 formed on one end, as shown. Alternatively, the hook portion 250 can be attached at an angle other than 90° in a so-called “waterfall” configuration (not shown).

Turning to FIG. 15, the bracket 246 is similar to the bracket 244, illustrated in FIG. 14. The only difference is the attachment of a knob 254 on the free end. The bracket 246 includes a connecting portion 256 and a hook portion.

FIG. 16 is a hat rack 260 formed on one end of a bracket. The hat rack 260 is configured to be attached to a slat in accordance with the present invention. The hat rack 260 includes a cup portion 262 connected to an “L” shaped support 263 connected on one end to the cup portion 262 and on the other end to a connecting portion 264. The cup portion 262 is similar to the cup portion 184, illustrated in FIG. 9 and may be formed to be 3 inches high and 4 inches in diameter. The ““L” shaped support 263 is formed from two legs 266 and 268 either connected together in a perpendicular relationship or from a single rod formed with the perpendicularly oriented legs 266 and 268. A free end of the leg 266 is connected to the cup portion 262, as discussed above, and a free end of the leg 266 is connected to the connecting portion 264, as discussed above. The “L” shaped support 263 may be formed from a 6 mm rod with the leg 266 formed to be 3 inches long and the leg 268 formed to be 6 inches long. The connecting portion may be formed in a “C” configuration with opposing bight portions 267 and 269 that are configured to receive the upper and lowers band rails 58 and 60 (FIG. 1) of a slat. One or both of the legs 270 and 272 may be formed to be flexible to allow the connecting portion 264 to be attached to the upper and lower rails 58 and 60. Alternatively, the hat rack 260 can be configured with a connecting portion, similar to the connecting portion 248, illustrated in FIG. 14.

The hat rack 260 provides enhanced functionality and versatility of a bracket for use with the slats in accordance with the present invention. In particular, the hat rack bracket 260 allows yet additional functionality to be incorporated into the slats in accordance with the present invention. In particular, the hat rack can be used to display a co-coordinating hat, for example, in addition to other items being displayed. In as much as the hat rack 260 is formed as slat, other coordinating items in addition to a hat can be displayed from the hat rack, such as jewelry.

FIG. 17 illustrates an exemplary earring card that can be carried and displayed by a slat in accordance with the present invention, as illustrated in FIG. 18. The earring card is formed from a generally flat substrate 276 with a connection portion 278 on one end. The substrate 276 includes a plurality of through holes, generally identified by the reference numeral 280. The through holes 280 are for receiving the posts (not shown) of the earrings. The posts are captured in place by the corresponding retainers (not shown). The connecting portion is configured to receive the slat rails 78 or 80 or the band rails 58 or 60, as shown in FIG. 18.

FIGS. 19a and 19b illustrate a merchandising shelf, generally identified with the reference numeral 300 that can be attached to a slat, such as the slat illustrated in FIG. 1. The merchandising shelf includes a shelf 302 and a plurality of mounting brackets, generally identified with the reference numeral 30, for attaching the shelf 300 to a slat 50, as illustrated in FIG. 1.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A slat for carrying brackets for displaying merchandise or carrying other items, the slat comprising:
an upper rail,
a lower rail;
a center band disposed between said upper rail and said lower rail;
a plurality of spokes connecting said center band to said upper rail and said lower rail; and
a plurality of slots formed between said upper rail and said center band and between said lower rail and said center band defining upper and lower slots, said slots formed to receive brackets.

2. The slat as recited in claim 1, wherein at least one pair of said upper and lower slots are at least partially aligned vertically to enable brackets to be received at different vertical heights at the same horizontal position.

3. The slat as recited in claim 1, wherein said center band includes at least one slot, formed to carry a bracket defining a center slot.

4. The slat as recited in claim 3, wherein said center slot is at least partially aligned vertically with one or the other of said upper slot or said lower slot.

5. The slat as recited in claim 3, wherein said upper slot, said lower slot and center slot are at least partially aligned vertically to enable three brackets to be carried at three different vertical heights at the same horizontal location.

6. The slat as recited in claim 1, wherein said slat is formed as a linear device.

7. The slat as recited in claim 1, wherein said slat is formed as a non-linear device.

8. The slat as recited in claim 7, wherein said slat is formed as a circular device.

9. The slat as recited in claim 1, wherein said slat is formed as a wall mounted device.

10. The slat as recited in claim 1, wherein said slat is formed as a freestanding device.

11. The floor standing device as recited in claim 10, comprising a freestanding floor frame for carrying at least one of said slats.

12. The floor standing device as recited in claim 11, further including at least two adjustable bracket assemblies for attaching at least one slat at each end to said free standing floor frame in order to enable the height of said and at least one slat to be adjusted.

13. The slat as recited in claim 1, wherein said slat is formed as a counter top freestanding device.

14. The counter top standing device as recited in claim 13, comprising a counter top base assembly for carrying said freestanding device.

15. The counter top standing device as recited in claim 13, wherein said counter top base assembly is rotatable.

16. The counter top standing device as recited in claim 14, wherein said counter top base assembly includes a slat.

17. A multifunctional merchandising table comprising:
a table top for carrying merchandise;
at least one leg for supporting said table top; and
at least one slat disposed beneath said table top.

18. The multi-functional merchandising table as recited in claim 17, wherein said slat comprises:
an upper rail,
a lower rail;
a center band disposed between said upper rail and said lower rail;
a plurality of spokes connecting said center band to said upper rail and said lower rail; and
a plurality of slots formed between said upper rail and said center band and between said lower rail and said center band defining upper and lower slots, said slots formed to receive brackets.

19. A multi-functional merchandising shelf comprising:
a mantle for carrying merchandise; and
at least one slat disposed beneath the mantle.

20. A merchandising display comprising:
an upright portion formed with a cylindrical configuration;
a base portion for supporting said upright portion; and
at least one slat formed on said upright portion.

21. The merchandising display as recited in claim 20, wherein said at least one slat comprises:
an upper rail,
a lower rail;
a center band disposed between said upper rail and said lower rail;
a plurality of spokes connecting said center band to said upper rail and said lower rail; and
a plurality of slots formed between said upper rail and said center band and between said lower rail and said center band defining upper and lower slots, said slots formed to receive brackets.

22. The merchandising display as recited in claim 20, wherein said upright portion is rotatable with respect to said base.

23. A hat stand display comprising:
a cup portion for carrying a hat;
a vertical support, attached to said cup portion; and
base attached to said vertical support, for supporting said cup portion, wherein said cup portion includes at least one slat.

24. A merchandising display for slim-carded items comprising:
a cylindrical structure having a plurality of tabs for carrying earring cards wherein at least a portion of said cylindrical structure is formed as a slat.

25. A merchandising display comprising:
a cylindrical structure for carrying headbands wherein at least a portion of said cylindrical structure is formed as a slat and another portion of said cylindrical structure may include a perforated pattern for carrying pierced earrings.

26. A merchandising display stand comprising:
a cylindrical portion with vertically oriented posts disposed along a upper edge of said cylindrical portion for carrying purses with straps;
a vertical support coupled to said cylindrical portion; and
a base connected to said vertical support, wherein said cylindrical portion is formed from a slat.

27. A hat tree display comprising:
a base;
a vertical support connected to said base.
a plurality of L shaped brackets attached on one end to said vertical supports; and
a plurality of cup portions connected to an opposing end of said L shape supports; wherein at least one cup portion is formed from a slat.

28. A hat rack comprising:
a cup portion for carrying a hat;
an L shaped support connected on one end to said cup portion; and
a connecting portion connected to an opposing end of said L shaped bracket, said connecting portion formed to be connected to a slat.

29. The hat rack as recited in claim 28, wherein said cup portion is formed from a slat.

30. A shelf for displaying merchandise, the shelf comprising:
a shelf; and
a plurality of brackets, attached to said shelf, for attaching said shelf to a slat.

31. A merchandising display comprising:
a plurality of spaced apart slats formed on a common substrate, each slat comprising:
a slat for carrying brackets for displaying merchandise or carrying other items, the slat comprising:
an upper rail,
a lower rail;
a center band disposed between said upper rail and said lower rail;
a plurality of spokes connecting said center band to said upper rail and said lower rail; and
a plurality of slots formed between said upper rail and said center band and between said lower rail and said center band defining upper and lower slots, said slots formed to receive brackets; wherein said merchandising display is configured for wall mounting.
